(19) United States
(12) Patent Application Publication
(10) Pub. No.: US 2026/0070560 A1
(43) Pub. Date: Mar. 12, 2026

(54) VEHICLE HAVING A DRIVE ARRANGEMENT WITH BRAKE DEVICE

(71) Applicant: Schaeffler Technologies AG & Co. KG, Herzogenaurach (DE)

(72) Inventors: Benedikt Grubauer, Neresheim (DE); Simon Ortmann, Pulheim (DE)

(73) Assignee: Schaeffler Technologies AG & Co. KG, Herzogenaurach (DE)

(21) Appl. No.: 19/106,230

(22) PCT Filed: Jul. 27, 2023
(86) PCT No.: PCT/DE2023/100555

§ 371 Date: Feb. 25, 2025

(30) Foreign Application Priority Data
Aug. 26, 2022 (DE) 10 2022 121 624.1

(51) Int. Cl. B60W 30/20; B60K 6/26; B60K 6/36; B60T 1/06; B60T 1/10; B60W 10/08; B60W 10/184; B60W 20/00

(52) U.S. Cl. CPC B60W 30/20; B60K 6/26; B60K 6/36; B60T 1/06; B60T 1/10; B60W 10/08; B60W 10/184; B60W 20/00; B60W 2510/0638; B60W 2710/08; B60W 2710/18; B60Y 2200/92; B60Y 2306/03; B60Y 2306/05; B60Y 2400/70; B60Y 2400/81

(57) ABSTRACT

A vehicle includes a drive arrangement and a brake device. The drive arrangement has an electric drive machine for generating a driving torque for the vehicle, and a step-up gearing for stepping up the driving torque. The step-up gearing has a gearing input for receiving the driving torque and a gearing output for outputting a stepped-up driving torque in the direction of at least one driven wheel of the vehicle such that a driving torque path from the drive machine to the gearing output and/or to the at least one driven wheel is formed. The brake device can be brought into operative connection with the driving torque path in order to bring a braking torque along a braking torque path onto the at least one driven wheel. The brake device has a friction brake device with a temperature control fluid for lubricating and/or cooling the friction brake device.

### CROSS-REFERENCE TO RELATED APPLICATIONS

This application is the United States National Phase of PCT Appln. No. PCT/DE2023/100555 filed Jul. 27, 2023, which claims priority to German Application No. 102022121624.1 filed Aug. 26, 2022, the entire disclosures of which are incorporated by reference herein.

### TECHNICAL FIELD

The present disclosure relates to a vehicle having a drive arrangement.

### BACKGROUND

For vehicles of classes M1 and N1 according to Regulation (EU) 2018/858, a service brake designed as a drum or disc brake is currently the state of the art. One brake is arranged on each wheel.

It is established practice for electrically powered vehicles of classes M1 and N1 to use both friction and recuperation brakes in mixed proportions during service braking. The size of the respective proportions depends on the driving situation. Emergency braking with high decelerations is handled by the friction brake, while moderate decelerations in urban traffic are largely generated by the recuperation brake.

### SUMMARY

The present disclosure provides a vehicle with a drive arrangement. In particular, the vehicle is designed as a hybrid vehicle or as a purely electric vehicle. The vehicle is realized, for example, as a passenger car, minibus, van or the like. The vehicle may be assigned to class MI or NI according to Regulation (EU) 2018/858. In particular, the vehicle is designed as a road vehicle and/or is approved and/or suitable for road traffic. For example, the vehicle can reach a maximum speed of more than 80 km/h, more than 120 km/h and in particular more than 140 km/h. Alternatively, the vehicle is designed as a rail vehicle.

The drive arrangement is designed to provide a driving torque for the vehicle, in particular a main driving torque for the vehicle.

The drive arrangement has an electric drive machine, in particular an electric motor, for generating the driving torque for the vehicle. It may be provided that the electric drive machine is the only traction machine for the vehicle. Alternatively, the vehicle has additional traction machines, for example additional electric drive machines and/or an internal combustion engine to generate the driving torque. The drive arrangement may provide at least 20%, in particular at least 40% and especially at least 80% of the driving torque for the vehicle.

The electric drive machine can be assigned to a single driven wheel of the vehicle and/or be designed as a single-wheel drive. Alternatively, the electric drive machine is assigned to two driven wheels, e.g., of a common axle and/or is designed as an electric axle. In other embodiments, the electric drive machine can also be assigned to all driven wheels and/or wheels of the vehicle and/or be designed as all-wheel drive.

The drive arrangement has a step-up gearing for stepping up the driving torque, which is introduced into the step-up gearing via a gearing input. An example method is to ‘step down’ from fast to slow, also known as gear reduction. The step-up gearing is designed to output a stepped-up driving torque based on the driving torque from the electric drive machine at a gearing output in the direction of the at least one driven wheel of the vehicle. For example, the step-up gearing has a gearing output via which the stepped-up driving torque is output in the direction of at least one driven wheel of the vehicle. Optionally, a distribution gearing, in particular a differential, and/or a summation gear for combining the stepped-up driving torque with other driving torques is connected downstream of the step-up gearing. Starting from the drive machine, a driving torque path runs to the gearing output and/or to the at least one driven wheel.

The vehicle, in particular the drive arrangement, has a brake device for generating a braking torque on the at least one driven wheel. Starting from the brake device, a braking torque path runs to the at least one driven wheel. Thus, the braking torque is generated by the brake device and directed to the at least one driven wheel via the braking torque path. The brake device acts on the driving torque path. In particular, the driving torque path and the braking torque path cross or meet upstream of the at least one driven wheel.

The brake device is designed in particular as a dynamic brake device and/or as a brake device for actuation during driving of the vehicle. In particular, the brake device is not designed as a parking brake or at least not as a pure parking brake.

Within the scope of the disclosure, it is proposed that the brake device has a friction brake device. The friction brake device implements the braking effect in particular via friction, especially via solid body friction, wherein two braking partners can be brought into frictional contact. The braking partners are designed in particular as solid bodies. The friction brake device has a temperature control fluid for lubricating and/or cooling the friction brake device. The cooling can in particular be designed as external cooling, wherein the temperature control fluid cools the friction brake device from the outside and in particular is arranged and/or runs without contact with the friction surfaces of the braking partners. Alternatively, the temperature control fluid is designed for internal lubrication and/or cooling of the friction brake device, such that the braking partners, in particular the friction surfaces of the braking partners, are in physical contact with the temperature control fluid and/or the friction surfaces of the braking partners are in physical contact with the temperature control fluid and/or the friction brake device is designed to be wet or wet-running.

The friction brake device is designed in particular as an encapsulated friction brake device. This design allows the friction brake device to be operated without emissions and avoids the escape of fine dust particles, as these are bound in particular by the temperature control fluid. The advantage of the wet friction brake device is also that it has a positive acoustic behavior. Any braking noise that may occur especially in dry braking systems is avoided, which improves operating behavior.

In particular, the friction brake device is designed as a wet-running multi-disc brake, wherein the multi-disc brake, in particular the brake discs, runs in the temperature control fluid for lubricating and/or cooling the multi-disc brake.

In particular, the multi-disc brake has an inner disc pack and an outer disc pack. The multi-disc brake has an actuator device, wherein the actuator device can set the multi-disc brake into a braking state or into a release state. The actuator device is designed, for example, as an axial actuator device which can apply an axial force to at least one of the disc packs. The actuator device can in particular be designed as a pneumatic, hydraulic and/or electrically acting actuator device.

In a possible further development of the disclosure, the vehicle has a temperature management device, wherein the temperature management device is designed to supply the braking heat of the brake device to a useful function via the temperature control fluid. In the useful function, the braking heat can be used, for example, to heat the step-up gearing, to control the temperature of the battery and/or to control the temperature of the passenger compartment.

It is possible that the brake device is designed as a passive heating device and that the braking heat is generated primarily from traffic-related braking.

In a possible further development of the disclosure, the brake device is designed to operate as an active heating device. The temperature management device controls the drive machine so that an additional driving torque is specifically directed from the electric drive machine to the brake device. Furthermore, the temperature management device controls the brake device to apply a corresponding additional braking torque in order to compensate for the additional driving torque. In this way, active braking heat is generated, which is fed to the useful function via the temperature management device.

In another possible further development, the brake device is designed to work as an active auxiliary heater: For this purpose, the drive arrangement has a drive coupling device which is designed to separate the driving torque path. The temperature management device is designed to control the drive coupling device so that the driving torque path is separated. In addition, the temperature management device controls the drive machine and the brake device to generate a driving torque, which is passed on to the brake device and is reduced again by the braking torque in order to actively generate braking heat when stationary. As before, the braking heat is directed to the useful functions via the temperature management device.

The vehicle may have a vibration management device which is designed to compensate and/or dampen and/or modulate vibrations in the drive arrangement, the drive machine, the step-up gearing and/or the vehicle as an vibrating system by controlling the brake device. For this purpose, the vibration management device has, for example, sensors for measuring the vibrations to be damped. In one possible embodiment, the vibration management device controls the brake device in order to actuate the brake device, in particular the friction brake device and/or multi-disc brake, in particular independently of a braking process, and thereby to dampen the vibrating system and/or to shift and/or modulate resonance frequencies. In general, the vibrating system is detuned by the actuation of the brake device, in particular the friction brake device and/or the multi-disc brake, so that the vibrations are damped and/or compensated.

In a further development, the brake device has a brake coupling device for separating the friction brake device, in particular the multi-disc brake, from the braking torque path. The vibration management device is designed to close the brake coupling device depending on the measured vibrations to be damped in order to compensate and/or dampen vibrations that occur. By closing the brake coupling device, the rotating masses of the brake device are connected to the vibrating system, so that the vibration behavior of the vibrating system changes in order to compensate for and/or dampen the occurring vibrations.

The vehicle may have a service brake, wherein the brake device is designed as a complementary brake to the service brake and/or a supplementary brake device to the service brake. This proposes a particularly advantageous application of the drive arrangement:
the service brake in the vehicle may be designed as a friction brake, in particular as a dry friction brake, especially as a disc and/or drum brake.

During the decelerations typical in urban traffic, the majority of the braking task is taken over by the friction brake or the recuperation brake. Shortly before the vehicle comes to a standstill, the use of the recuperation brake is not technically feasible; here the friction brake provides either the majority or the entirety of the required braking power.

In vehicles with the electric drive machine, the masking noise of the combustion engine is missing; in hybrid vehicles, the combustion engine may be deactivated. Previously irrelevant operating noises of the vehicle are noticed by the driver and can be perceived as disturbing. Thus, a reduction in noise emissions leads to an improvement in operating characteristics.

The regulations (for example UNECE 13H for vehicle class M1) also result in strict safety requirements for the service brake with regard to emergency braking, hot braking effect and reliability. Further requirements are to be expected in the future, most notably the limitation of the permissible emission of fine dust particles from the brakes.

A conflict of objectives can be derived from this field of tension: The friction brake must be able to meet the safety requirements, have high-quality acoustic behavior and at the same time reduce the emission of fine dust particles. In the event of an emergency braking, however, braking noise is insignificant. The focus here is solely on preventing accidents, i.e., damage to property and/or personal injury.

This conflict of objectives is mitigated by the vehicle having the drive arrangement: The brake device as a complementary brake and/or redundant brake device intervenes, for example, in urban environments where the friction brake can no longer resolve the conflict of objectives and/or the recuperation brake can no longer be used. It is emission-free and/or has positive acoustic behavior as a wet-running friction brake device, in particular a multi-disc brake.

Since the brake device as a complementary brake and/or supplementary brake device still requires a conventional service brake (for example designed as a disc or drum brake), the safety-relevant requirements continue to remain with the service brake, in particular with the friction brake. This improves the operating properties of the drive arrangement and/or the vehicle, taking into account safety and/or environmental requirements.

Towards the end of the deceleration process, the main braking deceleration can be generated by the service brake. This must be designed both for safe, controlled emergency braking from high speeds with a short braking distance, and also not produce any noise that the driver perceives as disturbing when braking from lower speeds. Since the brake device can replace the friction brake when braking from lower speeds, manufacturers of friction brakes can focus their optimization efforts on controlled emergency braking and gain new scope for action in the vehicle with the drive arrangement. During emergency braking, the acoustic behavior is of secondary importance compared to everyday braking in urban traffic. Since the brake device may not claim to have a safety function—the service brake remains intact and fully operational—it can be arranged upstream of the step-up gearing.

In a further development, the vehicle has a brake management device for controlling the service brake and the brake device.

The brake management device may be designed to implement an emergency braking state, wherein, in the emergency braking state, the service brake, in particular the friction brake, brings the vehicle to a standstill, wherein, in the emergency braking state, at least the main braking deceleration or the exclusive braking deceleration is implemented by the friction brake of the service brake. This means that all safety requirements are met.

Alternatively or additionally, the brake management device is designed to implement a recuperation braking state, wherein at least part of the braking deceleration is implemented by recuperation braking of the recuperation brake. This enables environmentally-conscious and comfortable driving.

Alternatively or additionally, the brake management device is designed to implement a comfort braking state, wherein the main braking deceleration is carried out by the brake device in order to bring the vehicle to a standstill. In particular, the brake management device is designed to implement the comfort braking state at speeds of less than 20 km/h, in particular less than 15 km/h and/or even in a range greater than 10 km/h. In these speed conditions, the recuperation braking can no longer work effectively, wherein in particular the brake device is used instead of the friction brake. In the comfort braking state, the braking of the vehicle to a standstill is achieved with little or no noise emission, since this is implemented completely or largely by the brake device.

An optional object of the disclosure relates to a method for operating the vehicle having the drive arrangement as previously described, wherein at least one of the operating states is implemented by the brake management device.

The temperature management device, the vibration management device and/or the brake management device may be designed as digital data processing devices.

The braking torque path may run via the step-up gearing, wherein the brake device is arranged in the braking torque path upstream of the step-up gearing. This means that the brake device is located in the drive arrangement in a section in which the driving torque has not yet been stepped up by the step-up gearing. In an example embodiment, the speed of the brake device is higher than the speed at the gearing output and/or at the driven wheel. The brake device may be arranged close to the drive machine and not close to the wheel. This position leads to two possible advantages: The brake device is arranged in an area in which the speed has not yet been stepped-up by the step-up gearing and is therefore higher than at the driven wheel and/or at the gearing output. This reduces the braking torque that the brake device has to apply, and the friction brake device, in particular a multi-disc brake, can be used instead of a dry friction brake.

In an example embodiment, the electric drive machine has a rotor shaft, wherein the brake device is connected to the rotor shaft in a braking readiness state or permanently rotationally coupled, e.g., rotationally fixed. Alternatively or additionally, it is claimed that the brake device is operated at the engine speed of the drive machine.

In a further development, the braking torque path runs via the electric drive machine, wherein the brake device is arranged in the braking torque path upstream of the electric drive machine. Thus, the braking torque is introduced by the brake device into the braking torque path, directed via the electric drive machine and via the step-up gearing and in particular via the gearing output and subsequently to the at least one driven wheel. The rotor shaft may be rotationally coupled, e.g., non-rotatably connected, with one axial side—optionally directly or, if necessary, with the interposition of further components—to the brake device and is rotationally coupled, e.g., non-rotatably connected, with the other side—optionally directly or, if necessary, with the interposition of further components—to the step-up gearing.

On the one hand, a driving torque path runs from the electric drive machine to at least one driven wheel. Furthermore, in this further development, a driving torque counter-path runs from the drive machine to the brake device, wherein a driving torque can also be transferred to the brake device. With respect to the driving torque counter-path, the brake device forms an end point or a dead-end, as the driving torque of the electric drive machine is not passed through the brake device. In particular, the brake device forms a dead-end path for the driving torque counter-path.

From a drive technology perspective, the electric drive machine in this further development is arranged between the brake device and the step-up gearing. This arrangement makes it particularly easy to integrate the brake device, as there is no need to intervene in the driving torque path. Rather, the brake device can be arranged on one side of the drive machine and the step-up gearing on the other side of the drive machine.

In an alternative embodiment, the brake device is arranged in the driving torque path between the drive machine and the step-up gearing. In particular, the brake device acts on a connecting shaft or a connecting shaft section between the drive machine and the step-up gearing. In this configuration, the drive arrangement can be implemented particularly compactly.

In a further alternative embodiment, the brake device is arranged outside the driving torque path. In particular, the gearing input of the step-up gearing forms a branch point, wherein the driving torque path and the braking torque path meet for the first time at the branch point. From a structural point of view, the drive machine is arranged on one axial side of the step-up gearing and the brake device is arranged on the other side of the step-up gearing. On the one hand, a driving torque path runs from the electric drive machine to at least one driven wheel. Furthermore, in this further development, a driving torque branch path runs without being stepped up from the drive machine through the step-up gearing to the brake device, wherein a driving torque can also be transmitted to the brake device. With respect to the driving torque branch path, the brake device forms an end point or a dead-end, as the driving torque of the electric drive machine is not passed through the brake device. In particular, the brake device forms a dead-end path for the driving torque branch path.

In an example implementation, the brake device and the rotor shaft are arranged coaxially, wherein the brake device has a brake rotational axis which is aligned coaxially to the axis of rotation of the rotor shaft. This implementation allows the drive arrangement to be made particularly compact, so that the integration effort is reduced and the operating properties are improved.

In an example development, the drive arrangement has an additional module, wherein the additional module has a module housing, wherein the brake device is arranged in the module housing. The drive arrangement has a main housing, wherein the drive machine and optionally additionally the step-up gearing are arranged in the main housing. In particular, the additional module forms an independent subassembly. The additional module may be attached to the main housing in a detachable manner, in particular in a non-destructive manner. For example, the additional module, in particular the module housing, is flanged, screwed and/or detachably attached to the main housing for easy assembly. In particular, the additional module is arranged on the main housing to support the braking torque, so that counterforces occurring when the braking torque is generated can be diverted from the brake device via the module housing to the main housing.

The main housing may form an electric axle and/or another, independent subassembly with the drive machine and optionally additionally with the step-up gearing. This further development makes it easier to mount the additional module with the brake device on already developed drive units, in particular electric axles, so that the integration effort is reduced. In this way, the additional module can be used as an independent assembly in a variety of different drive units.

A further optional object of the disclosure relates to the additional module for the vehicle and/or the drive arrangement as previously described. The additional module has a module housing for connection to the main housing and the brake device, wherein the brake device is arranged in the module housing. In particular, the additional module is designed as an independent subassembly. The additional module forms an end point for a path, in particular the driving torque counter-path or the driving torque branch path via which a driving torque can be introduced into the additional module. In particular, the additional module is designed as a dead-end module with only a single torque interface.

Possible advantages depending on the embodiment may include:
Very long service intervals (“virtually lifetime brake”).
Advantageous acoustic behavior because the brake device is completely encapsulated.
No influence from weather or other environmental conditions on the vehicle.
At speeds and decelerations typical in urban areas, the previously necessary use of the friction brake towards the end of the deceleration process can be omitted. At this operating point, braking noise from conventional friction brakes is most noticeable to the driver.
A temperature control fluid is used to dissipate the resulting braking heat. The heated temperature control fluid is advantageously used to control the temperature of the battery and gearing as well as to heat the passenger compartment. This allows the energy efficiency of the vehicle to be increased through the use of the brake device.
The small amount of wear particles that are created are bound in the temperature control fluid and thus cannot enter the environment. Through the mixed use of the brake device and recuperation brake, an emission-free brake device can be realized, in particular in urban environments.

As already described, towards the end of the deceleration process, the main braking deceleration is generated by the service brake. This must be designed both for safe, controlled emergency braking from high speeds with a short braking distance, and also not produce any noise that the driver perceives as disturbing when braking from lower speeds. Since the friction brake is replaced when braking from lower speeds, manufacturers of friction brakes can focus their optimization efforts on controlled emergency braking and gain new scope for action in a vehicle with an additional brake device installed. During emergency braking, the acoustic behavior is of secondary importance compared to everyday braking, in particular in urban traffic.

Since the brake device does not claim to have a safety function—the service brake remains intact and fully operational—it can be arranged upstream of the differential, for example.

### BRIEF DESCRIPTION OF THE DRAWINGS

Further features, advantages and effects of the disclosure result from the following description of exemplary embodiments and the attached figures. In the figures:

FIG. 1 shows a highly schematic block diagram of a drive arrangement for a vehicle and the vehicle as an exemplary embodiment;

FIG. 2 a, b, c each show a block diagram for a first, a second and a third exemplary embodiment;

FIG. 3 shows a possible structural design of the drive arrangement according to the first exemplary embodiment;

FIG. 4 shows a possible structural design of a brake device for the drive arrangement;

FIG. 5 shows a possible structural design of the drive arrangement according to the second exemplary embodiment;

FIG. 6 shows a possible structural design of the drive arrangement according to the third exemplary embodiment;

FIG. 7 a, b show two embodiment variants of a method for vibration damping;

FIG. 8 shows a possible structural design of the drive arrangement for vibration damping;

FIG. 9 shows an embodiment variant of a method for active braking heat generation; and

FIG. 10 shows a possible structural design of the drive arrangement for braking heat generation.

### DETAILED DESCRIPTION

Identical or corresponding components, areas and paths are provided with identical or corresponding reference symbols.

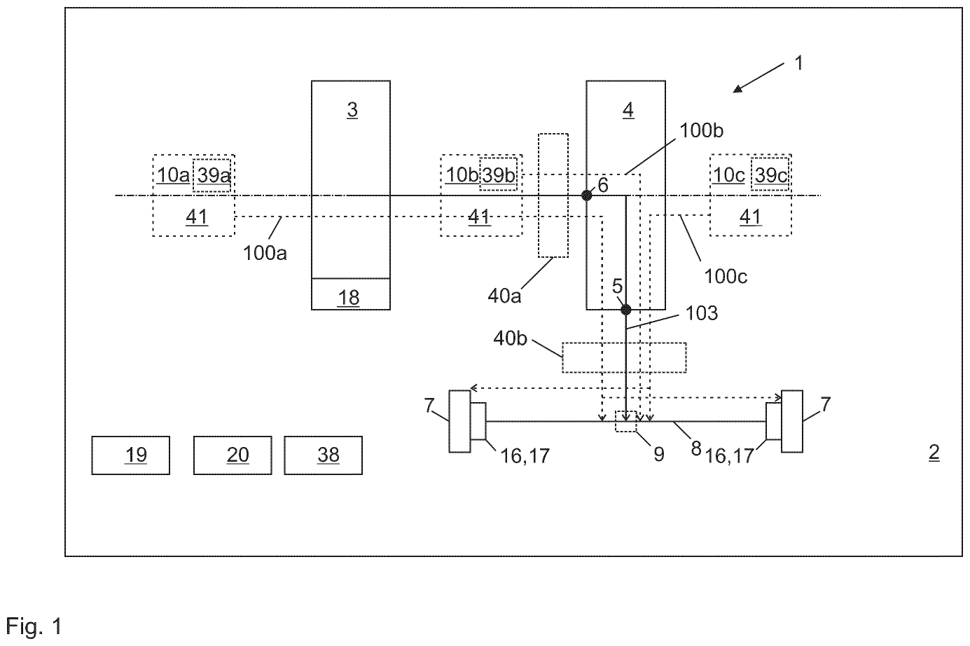

FIG. 1 shows a drive arrangement 1 for a vehicle 2 in a schematic block diagram. The vehicle 2 is designed, for example, as a passenger car. In particular, the vehicle 2 is realized as an electric vehicle. The drive arrangement 1 has an electric drive machine 3, wherein the electric drive machine 3 is designed for generating a driving torque for the vehicle 2. In particular, the drive machine 3 is designed as an electric motor. Optionally, the drive machine 3 can be used as a generator.

The drive arrangement 1 has a step-up gearing 4, which is designed to step up the driving torque from the drive machine 3, namely “from fast to slow”. The step-up gearing 4 has a gearing output 5 and a gearing input 6, wherein the rotational speed at the gearing output 5 is lower than at the gearing input 6.

The vehicle 2 has at least one driven wheel 7. In the exemplary embodiment shown, the vehicle 2 has two driven wheels 7 of a common axle 8. The stepped-up driving torque generated by the step-up gearing 4 is directed towards the driven wheels 7. For example, a differential 9 can be interconnected in the torque flow. Alternatively, only one driven wheel 7 is provided, wherein the drive arrangement 1 is designed as a single-wheel drive. It is also possible that the driving torque is distributed to driven wheels 7 of different axles 8.

A driving torque path 103 is formed, which runs from the drive machine 3 into the gearing input 6 and/or the step-up gearing 4 and subsequently leads to the driven wheels 7, in particular via the gearing output 5.

Optionally, a drive coupling device 40 a, b is provided, wherein the drive coupling device 40 a, b is designed to separate the driving torque path 103 downstream of the drive machine 3. This allows the drive machine 3 to rotate without any driving torque being transferred to the gearing output 5 or to the driven wheels 7. FIG. 1 shows two different exemplary embodiments for the position of the drive coupling device 40 a, b. Alternatively, in further exemplary embodiments, the drive coupling device can be arranged in the step-up gearing 4 or downstream of the differential 9. The drive coupling device 40 a is arranged between the drive machine 3 and the step-up gearing 4. In the event that the brake device 10 b is used, the brake device 10 b is arranged in the driving torque path 103 upstream of the drive coupling device 40 a. The drive coupling device 40 b is arranged in the driving torque path 103 downstream of the gearing output 5.

The drive arrangement 1 has a brake device 10 a, b, c, which is designed to generate a braking torque on or for the driven wheel(s) 7 and to direct it to the driven wheels 7 via a respective braking torque path 100 a, b, c. FIG. 1 shows three different exemplary embodiments for the position of the brake device 10 a, b, c as well as for the braking torque paths 100 a, b, c, which are selected alternatively.

The brake device 10 a, b, c is designed in particular as a dynamic brake and is not limited to the function of a parking brake. In particular, the brake device 10 a, b, c can be used to brake the vehicle 1 from a driving speed of, for example, more than 20 km/h to a standstill.

The braking torque paths 100 a, b, c each run via the step-up gearing 4, wherein the brake device 10 a, b, c is arranged upstream of the step-up gearing 4 with respect to the respective braking torque path 100 a, b, c in the torque flow direction of the braking torque.

In the first exemplary embodiment, the brake device 10 a is arranged in the braking torque path 100 a upstream of the electric drive machine 3. The braking torque path 100 a thus runs from the brake device 10 a, which generates the braking torque, via the electric drive machine 3, subsequently via the step-up gearing 4 and at least one driven wheel 7.

In the second exemplary embodiment, the brake device 10 b is arranged in the driving torque path 103 between the drive machine 3 and the step-up gearing 4. The braking torque path 100 b thus runs from the brake device 10 b, which generates the braking torque, via the step-up gearing 4 to the at least one driven wheel 7. The drive machine 3 is arranged outside the braking torque path 100 b.

In the third exemplary embodiment, the brake device 10 c is arranged in the braking torque path 100 c with respect to the step-up gearing 4 on a different axial side than the drive machine 3. The braking torque path 100 c thus runs from the brake device 10 c, which generates the braking torque, via the step-up gearing 4 to the at least one driven wheel 7. The drive machine 3 is arranged outside the braking torque path 100 c.

What the three positions of the brake device 10 a, b, c have in common is that the brake device 10 a, b, c is operated at the engine speed of the drive machine 3 or at least at a speed that is not generated via the step-up gearing 4.

The brake device 10 a, b, c can optionally each have a brake coupling device 39 a, b, c, which enables a decoupling of the respective brake device 10 a, b, c from the driving torque path 103 and/or from the respective braking torque path 100 a, b, c. The brake coupling device 39 a, b, c is designed, for example, as a synchronization device, so that the brake coupling device 39 a, b, c can be selectively set to a braking readiness state or to a freewheel state. In the braking readiness state, the brake device 10 a, b, c is coupled and rotates in readiness for braking. In the release state, the brake device 10 a, b, c is disengaged so that any drag torques caused by rotating masses of the brake device 10 a, b, c are reduced.

In addition to the brake device 10, the vehicle 2 optionally has a service brake 16, wherein the service brake 16 comprises a friction brake 17, which is designed, for example, close to the wheel as a disc brake or as a drum brake. The vehicle 2 optionally has a recuperation brake 18, which is implemented by the drive machine 3 in a generator operation. The recuperation brake 18 can be common to, but also independent of, the service brake 16.

With the service brake 16, the vehicle 2 has an approved deceleration system. The brake device 10 a, b, c is designed, for example, as a complementary brake and/or as a supplementary brake device to the service brake 16, which does not perform any safety-relevant functions but rather a comfort function with regard to the braking of the vehicle.

The drive arrangement 1 optionally has a brake management device 19, wherein the brake management device 19 is designed to control the service brake 16, the optional recuperation brake 18 and the brake device 10. The brake management device 19 can be designed, for example, as a digital data processing device and/or as an analog switching device. The brake management device 19 is designed to control the service brake 16 and in particular the friction brake 17 in an emergency braking state when a high braking deceleration is required, so that the latter takes over the main braking deceleration. This ensures that, in the emergency braking state, the safety-relevant service brake 16 implements the emergency braking.

Furthermore, the brake management device 19 is designed to implement the braking deceleration by the recuperation brake 18 in a recuperation braking state. This improves the energy management of the vehicle 2.

The brake management device 19 is designed to control the brake device 10 and the service brake 16 in a comfort braking state such that the main braking deceleration is carried out primarily or exclusively by the brake device 10 a, b, c. For example, the brake management device 19 is designed, in particular, to implement the comfort braking state when braking the vehicle at lower speeds below 20 km/h, in particular less than 10 km/h, without the service brake 16, in particular without the friction brake 17 and/or exclusively by means of the brake device 10. Optionally, the recuperation brake 18 can support the comfort braking state.

The brake device 10 a, b, c is designed in particular as a wet, in particular wet-running brake device 10 a, b, c and as a friction brake device. The brake device 10 a, b, c can have a multi-disc brake 41. The wet-running property ensures that virtually no acoustic emissions are generated in the braking state of the brake device 10 a, b, c. The significant or even exclusive use of the brake device 10 a, b, c increases comfort and thus improves operating properties. The background to this braking strategy of the comfort braking state is that the recuperation brake 18 no longer works effectively in the slow speed states, while at the same time the use of the acoustically disadvantageous friction brake 17 is avoided.

Alternatively or additionally, the brake management device 19 is designed to monitor the brake coupling device 39 a, b, c and to control the freewheel state or the braking readiness state.

Optionally, the drive arrangement 1 additionally has a temperature management device 20, wherein the temperature management device 20 is designed to supply the braking heat generated in the wet-running brake device 10 in a temperature control fluid of the brake device 10 to an additional function in the vehicle 2. In the useful function, the braking heat can be used, for example, to heat the step-up gearing, to control the temperature of the battery and/or to control the temperature of the passenger compartment. In particular, the mixed use of the brake device 10 a, b, c in conjunction with the recuperation brake 18 is intended. This mixed use leads to low energies that must be converted during the braking process. By means of pumps, the temperature control fluid is pumped to other locations in the vehicle 2 and can be used, for example, to heat the gearing, to control the temperature of the battery and to control the temperature of the passenger compartment. This increases the energy efficiency of the vehicle 2 by making use of energy that was previously dissipated unused into the environment.

The temperature management device 20 can be designed to advantageously distribute the braking heat generated during normal driving operation. In this embodiment, the brake device 10 a, b, c is used as a passive heating device.

It is also possible to use the brake device 10 a, b, c as a “friction heater” during driving and/or as an active heating device: For this purpose, the brake device 10 a, b, c designed as a wet friction brake device or multi-disc brake 41 actively generates temperature by generating a braking torque which generates thermal energy. However, the braking torque is simultaneously compensated by an increase in the engine torque of the drive machine 3 in order to keep the speed of the vehicle constant. In the active heating state, the brake device 10 a, b, c and the drive machine 3 work against each other to actively generate braking heat.

It is also possible to use the brake device 10 a, b, c as an active auxiliary heater: In this case, the temperature management device 20 controls the drive coupling device 40 a, b, in particular when the vehicle 1 is at a standstill, in order to disconnect the driving torque path 103. Furthermore, the drive motor 3 is controlled to generate a driving torque which is directed to the brake device 10 a, b, c. In addition, the brake device 10 a, b, c is controlled to carry out braking in order to cancel the driving torque by the braking torque, so that braking heat is actively generated when the vehicle 2 is stationary. The braking heat can be used for the useful functions already described.

The drive coupling device 40 a, b makes it possible to operate the drive machine 3 independently of the driving state, i.e., even when stationary (similar to idling in a combustion engine). This makes it possible to continue operating the brake device 10 a, b, c, which is coupled to the drive machine 3, and thus to generate braking heat, which can subsequently be used, for example, to heat the battery and the interior or for other useful functions. This means that the system can also be operated as an auxiliary heater when the vehicle is at a standstill, for example. No additional or fewer heating components are required.

The positioning of the brake device 10 a, b, c upstream of the step-up gearing 4 is advantageous because it can be controlled directly with the engine speed. This allows for higher speeds at lower torques in typical applications.

Optionally, the vehicle has a vibration management device 38, wherein the vibration management device 38 is designed to compensate and/or dampen vibrations in the drive arrangement 1, in the driving torque path 103, in the braking torque path 100, in the drive machine 3, in the step-up gearing 4 and/or in the vehicle 2—collectively referred to as the system—by monitoring, in particular controlling, the brake device 10 a, b, c.

The vibration management device 38 can detect the vibrations to be damped by suitable sensors. Examples of sensors are vibration sensors, speed sensors, acoustic sensors, etc. The brake device 10 a, b, c is controlled on the basis of the detected vibrations to be damped. In particular, the control takes place independently of any control as a brake during driving.

The vibration damping function can be implemented by controlling the friction brake device, in particular the multi-disc brake 41, i.e., the actual brake actuator. The control can generate damping and/or counter-vibration in order to compensate and/or dampen the vibration to be damped. In particular, active vibration damping is implemented.

Alternatively or additionally, the vibration damping function can be implemented by controlling the brake coupling device 39 a, b, c by switching it from the freewheel state to the braking readiness state. In this case, a damping component is activated in the vibrating system by the multi-disc brake 41 or general friction brake device running in the temperature control fluid, so that damping is implemented. In the event that the brake coupling device 39 a, b, c is designed as a synchronization device, the brake coupling device 39 a, b, c can also be controlled in a sliding or frictional manner and thus in an intermediate state between the release state and the braking readiness state. This enables a gradual damping and/or compensation of the vibration to be damped by the vibration management device 38.

If the effect on the oscillation to be damped is considered as a detuning of the system to be damped, a first possibility of detuning is achieved by switching on and/or synchronizing. As a result, the rotatable portion of the multi-disc brake 41 is coupled to the drive machine 3 as a friction brake device, wherein the additional mass detunes the system.

Alternatively or additionally, the rotatable part of the multi-disc brake 41 can be applied as a friction brake device, in particular after it has been coupled, wherein the system can be fully variably detuned.

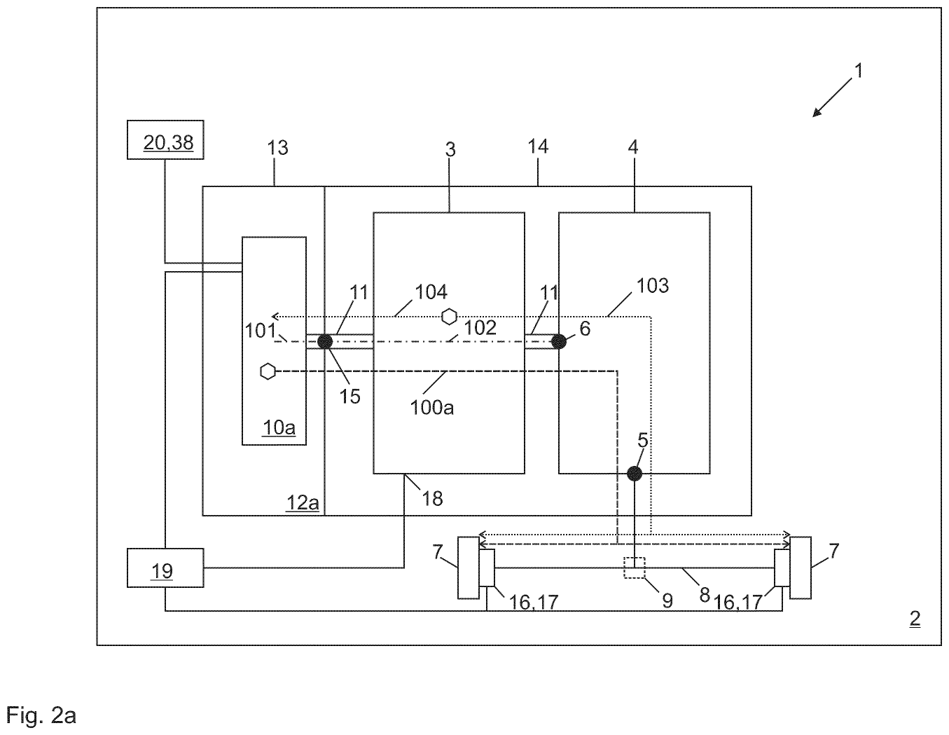

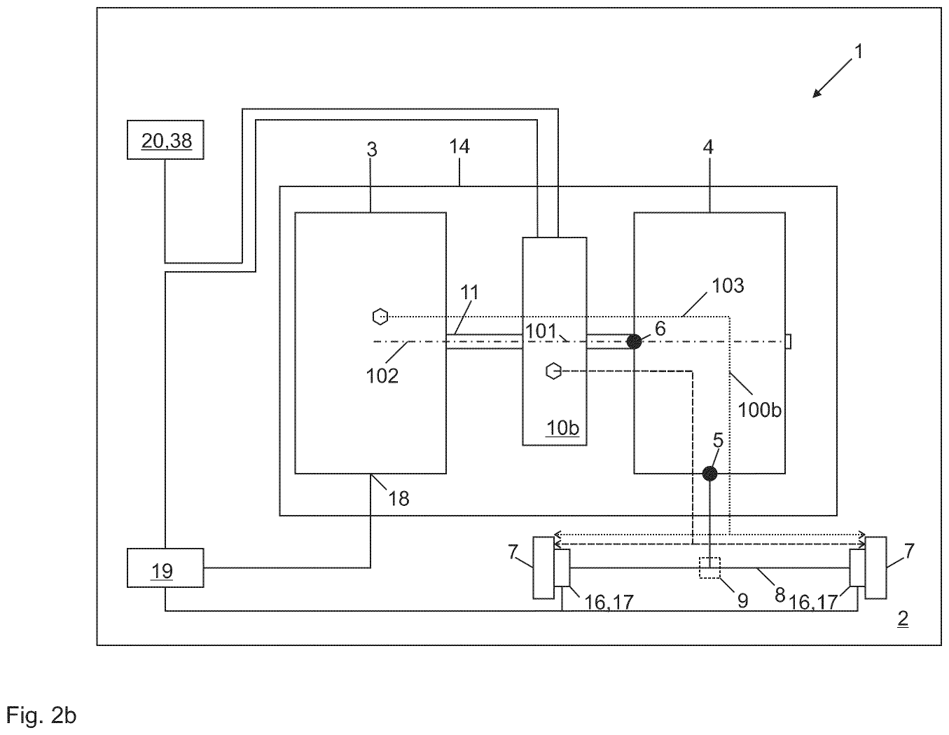

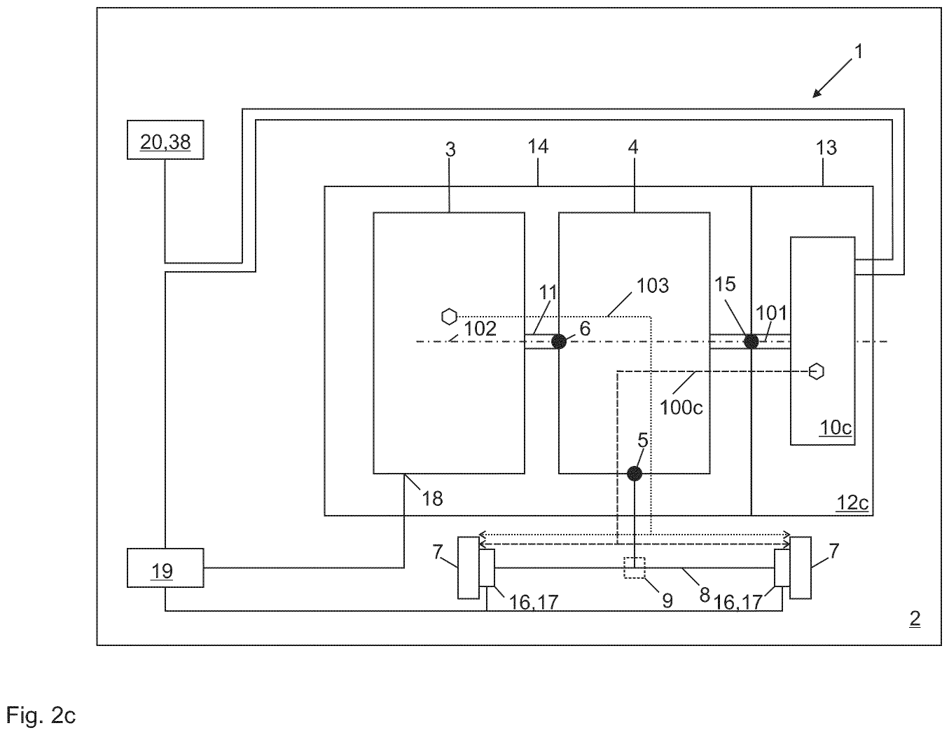

FIG. 2 a shows the first exemplary embodiment with the brake device 10 a in a schematic, alternative representation.

The drive machine 3 has a rotor shaft 11, wherein the rotor shaft 11 is rotationally coupled and/or rotationally fixedly connected to the brake device 10 a. In the exemplary embodiment shown in FIG. 2 a, a brake rotational axis 101 is aligned coaxially to a rotor rotational axis 102 of the rotor shaft 11. The brake device 10 a is permanently rotationally coupled and/or rotationally fixedly connected to the rotor shaft 11 or, in the event that the brake device 10 a has the brake coupling device 39 a, at least in the braking readiness state. On an axial side of the rotor shaft 11 opposite the brake device 10 a, the latter is connected in a rotationally fixed manner to the gearing input 6 of the step-up gearing 4. Thus, the rotor shaft 11 and thereby the drive machine 3 are thus operatively connected to the brake device 10 a on one axial side and to the step-up gearing 4 on the other axial side. This positioning enables a particularly simple integration and design of the brake device 10 a and/or the drive arrangement 1. The braking torque path 100 a thus runs from the brake device 10 a via the drive machine 3, the step-up gearing 4, to the gearing output 5.

The drive arrangement 1 has the additional module 12 a, wherein the additional module 12 a has a module housing 13, wherein the brake device 10 a is arranged in the module housing 13. The drive arrangement 1 further comprises a main housing 14, wherein at least the drive machine 3 and optionally additionally the step-up gearing 4 are arranged in the main housing 14. The additional module 12 a and/or the module housing 13 is detachably connected to the main housing 14. Thus, the additional module 12 a can be easily coupled to the main housing 14 and thus to the electric drive machine 3 for maintenance or retrofitting purposes.

Furthermore, a driving torque counter-path 104 is formed, which runs in particular in the opposite direction to the driving torque path 103 and runs from the electric drive machine 3 via the rotor shaft 11 into the additional module 12 a and/or into the brake device 10 a. For this driving torque counter-path 104, the additional module 12 a and/or the brake device 10 a forms a dead-end module and/or an end point. In particular, the additional module 12 a and/or the brake device 10 a has only a single and/or common torque interface 15, which is designed as an output for the braking torque and/or as an input for the driving torque from the drive machine 3.

Optionally, the vehicle 2 can additionally have the brake coupling device 39 a and/or the drive coupling device 40 a, b. These are not shown for graphical clarity.

The brake management device 19 is connected in terms of signaling to the optional recuperation brake 18, the brake device 10 a and the service brake 16. The temperature management device 20 is connected in terms of signaling to the brake device 10 a and optionally additionally to the drive coupling device 40 a, b or in another design and/or to the drive machine 3. The vibration management device 38 is connected to the brake device 10 a in terms of signaling.

FIG. 2 b shows the second embodiment with the brake device 10 b in a schematic, alternative representation.

The drive machine 3 has the rotor shaft 11, wherein the rotor shaft 11 is rotationally coupled and/or rotationally fixedly connected to the brake device 10 b. In the exemplary embodiment shown in FIG. 2 b, a brake rotational axis 101 is aligned coaxially to a rotor rotational axis 102 of the rotor shaft 11. The brake device 10 b is permanently rotationally coupled and/or rotationally fixedly connected to the rotor shaft 11 or, in the event that the brake device 10 b has the brake coupling device 39 b, at least in the braking readiness state. With respect to the driving torque path 103, the brake device 10 b is arranged downstream of the drive machine 3 and upstream of the step-up gearing 4. For example, the brake device 10 b can be integrated into the main housing 4. This positioning enables a particularly compact integration and design of the brake device 10 b and/or the drive arrangement 1. The braking torque path 100 b thus runs from the brake device 10 b via the step-up gearing 4 to the gearing output 5.

Optionally, the vehicle 2 can additionally have the brake coupling device 39 b and/or the drive coupling device 40 b or another drive coupling device. These are not shown for graphical clarity.

The brake management device 19 is connected in terms of signaling to the optional recuperation brake 18, the brake device 10 b and the service brake 16. The temperature management device 20 is connected in terms of signaling to the brake device 10 b and optionally additionally to the drive coupling device 40 b or in another design and/or to the drive machine 3. The vibration management device 38 is connected to the brake device 10 a in terms of signaling.

FIG. 2 c shows the third exemplary embodiment with the brake device 10 c in a schematic, alternative representation.

The drive machine 3 has the rotor shaft 11, wherein the rotor shaft 11 is rotationally coupled and/or rotationally fixedly connected to the brake device 10 a via the step-up gearing 4. In the exemplary embodiment shown in FIG. 2 c, the brake rotational axis 101 is aligned coaxially to a rotor rotational axis 102 of the rotor shaft 11. The brake device 10 c is permanently rotationally coupled and/or rotationally fixedly connected to the rotor shaft 11 or, in the event that the brake device 10 c has the brake coupling device 39 c, at least in the braking readiness state. The step-up gearing 4 is arranged between the drive machine 3 and the brake device 10 c with respect to the rotor rotational axis 102 and/or the brake rotational axis 101. Thus, the step-up gearing 4 is operatively connected with one axial side to the drive machine 3 and with the other axial side to the brake device 10 c. In particular, the brake device 10 c rotates at the speed of the drive machine 3.

This positioning enables a particularly simple integration and design of the brake device 10 c and/or the drive arrangement 1. The braking torque path 100 c thus runs from the brake device 10 c via the step-up gearing 4 to the gearing output 5.

The drive arrangement 1 has the additional module 12 c, wherein the additional module 12 c has a module housing 13, wherein the brake device 10 a is arranged in the module housing 13. The drive arrangement 1 further comprises the main housing 14, wherein at least the step-up gearing 4 and optionally additionally the drive machine 3 are arranged in the main housing 14. The additional module 12 c and/or the module housing 13 is detachably connected to the main housing 14. Thus, the additional module 12 c can be easily coupled to the main housing 14 and thus to the step-up gearing 4 and/or the electric drive machine 3 for maintenance or retrofitting purposes.

Furthermore, a driving torque branch path 105 is formed, which branches off from the driving torque path 103 and runs from the electric drive machine 3 via the transmission drive 4 into the additional module 12 c and/or into the brake device 10 d. For this driving torque branch path 105, the additional module 12 c and/or the brake device 10 c forms a dead-end module and/or an end point. In particular, the additional module 12 c and/or the brake device 10 c has only a single and/or common torque interface 15, which is designed as an output for the braking torque and/or as an input for the driving torque from the drive machine 3 and/or the step-up gearing.

Optionally, the vehicle 2 can additionally have the brake coupling device 39 c and/or the drive coupling device 40 a, b or other drive coupling devices. These are not shown for graphical clarity.

The brake management device 19 is connected in terms of signaling to the optional recuperation brake 18, the brake device 10 c and the service brake 16. The temperature management device 20 is connected in terms of signaling to the brake device 10 c and optionally additionally to the drive coupling device 40 a, b or in another design and/or to the drive machine 3. The vibration management device 38 is connected to the brake device 10 c in terms of signaling.

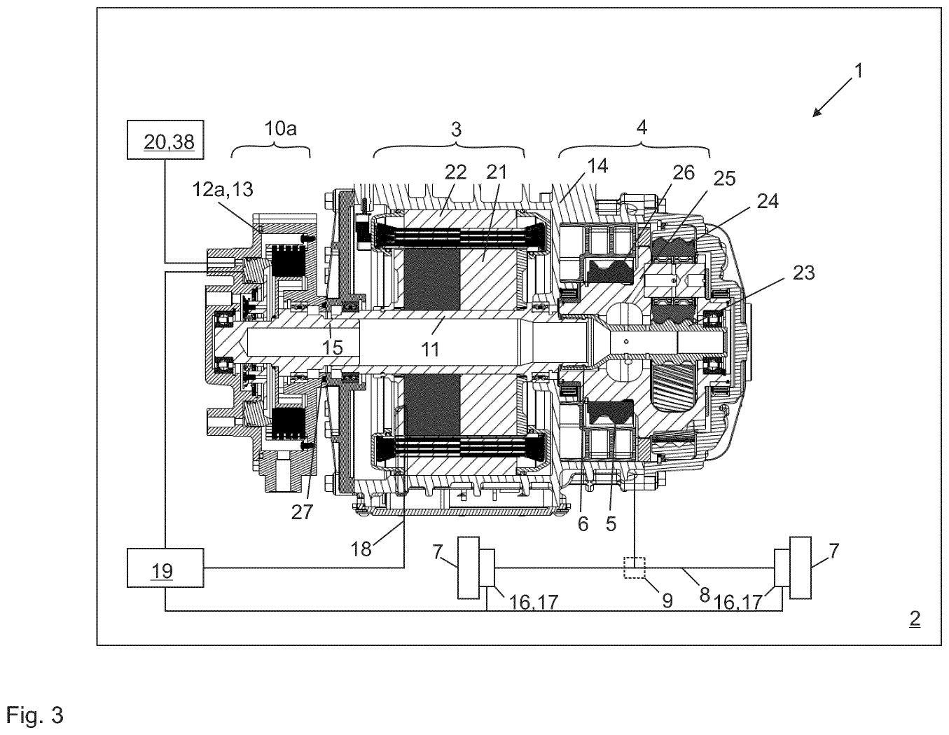

FIG. 3 shows a schematic longitudinal section through a structural design of the drive arrangement 1 according to the first exemplary embodiment of the disclosure, wherein the same components and areas are provided with the same reference symbols as in FIG. 1, so that reference is made to the previous description and only the structural details are discussed below. For the torque paths, reference is also made to the previous figures.

The centrally arranged electric drive machine 3 has a rotor 21 which is connected in a rotationally fixed manner to the rotor shaft 11. A stator 22 of the electric drive machine 3, however, is arranged in the main housing 14 in a stationary manner.

The step-up gearing 4 is designed as a planetary gearing, wherein the rotor shaft 11 in the gearing input 6 is connected to a sun shaft 23, which meshes with a plurality of planetary gears 24, which are rotatably arranged in a planetary carrier 25 on a common pitch circle. The planetary carrier 25 forms the gearing output 5 and has, for example, a circumferential spur gear toothing 26. The step-up gearing 4 is arranged together with the electric drive machine 3 in the main housing 14. An area of the drive arrangement 1 in which the power electronics for the drive machine 3 are arranged is cut off graphically.

On the left side, the brake device 10 a can be seen in the additional module 12 a. The additional module 12 a has the module housing 13, wherein the additional module 12 a and/or the module housing 13 is detachably connected to the main housing 14 via screw connections 27.

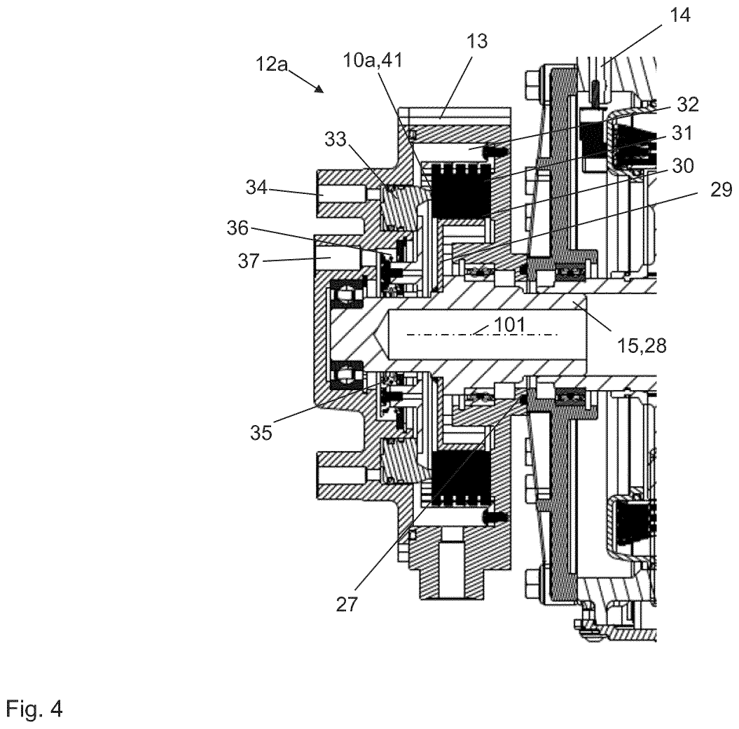

FIG. 4 shows a detailed view of the additional module 12 a designed as a low-energy brake from FIG. 3. Via an input shaft 28, which forms the torque interface 15, the brake device 10 a is directly connected to the motor shaft in the form of the rotor shaft 11 (FIG. 2) of the electric drive machine 3. The torque transmission can, for example, be carried out via a toothing on the input shaft 28 with corresponding counter toothing on the motor shaft/rotor shaft 11 (FIG. 3).

A toothed inner ring 29 is arranged on the input shaft 23. The two components can, for example, be designed as a welded assembly; alternatively, both components can be integrated into a single component. The torque is transmitted via the toothed inner ring 29 to a plurality of friction discs 30, which form an inner disc pack. For this purpose, a toothing is introduced into the inner diameter of the friction discs 30. To generate the braking torque, the friction discs 30 are pressed against a plurality of steel discs 31, which form an outer disc pack. The steel discs 31 are secured against rotation by means of an external toothing in a toothed outer ring 32 but are mounted so as to be axially displaceable. The support of the braking torque runs via the toothed outer ring 32 over the module housing 13 into the main housing 14, wherein the transmission of the torque can be realized, for example, by a screw connection, toothing or the like. The screw connections 27 are shown.

The axial force required to generate the braking torque can, for example, be achieved by means of hydraulic pressure. Another possibility is to generate the axial force by means of an electric drive. For this purpose, an annular gap is formed in the module housing 13, in which a piston 33 is arranged so as to be axially displaceable. The annular gap is sealed by sealing rings arranged on the inner and outer diameters; pressure can be built up. Optional sliding bands can be used to guide the piston. If hydraulic pressure is built up, the piston 33 is displaced against the steel disc 31; the required axial force is built up. The hydraulic fluid required to build up pressure is fed into the annular pressure chamber via holes 34 in the module housing 13.

If no deceleration is requested and the system is in a pressureless state, the piston 33 is pressed into its initial position by springs 35. Spring plates are used to transmit force between the springs 35, module housing 13 and piston 33. The module housing 13 can be constructed from two housing halves as shown, wherein the connection of the housing halves must be able to support the axial force required to generate the braking torque. A seal is arranged between the two housing halves; this is designed as an O-ring, for example. This forms a module interior 36, wherein the temperature control fluid for tempering and lubricating the friction discs 30 and the steel discs 31 is arranged in the module interior 36. The temperature control fluid can be connected to a temperature control circuit via further holes 37, so that the braking heat generated during braking can be dissipated with the temperature control fluid and the braking heat can be fed to the useful functions.

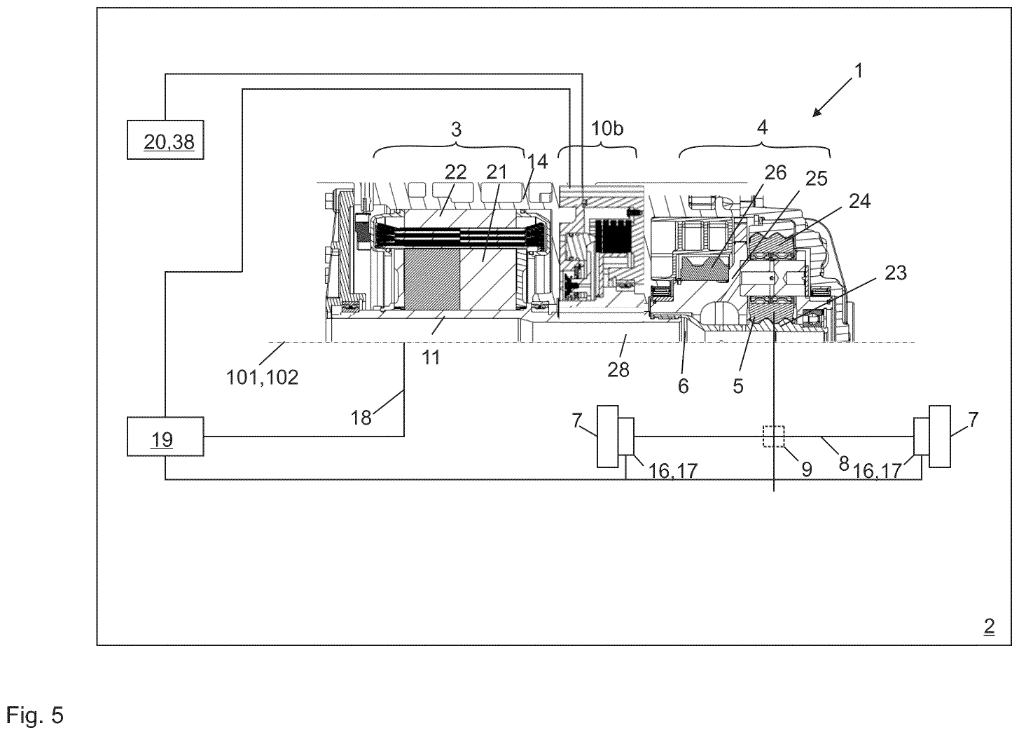

FIG. 5 shows a schematic longitudinal section through a structural design of the drive arrangement 1 according to the second exemplary embodiment of the disclosure, wherein the same components and areas are provided with the same reference symbols as in FIG. 1, so that reference is made to the previous description and only the structural details are discussed below. For the torque paths, reference is also made to the previous figures. For the structural details of the drive arrangement 1, reference is made to the description of FIG. 3, wherein only the differences are described below. For the structural details of the brake device 10 b, reference is made to the description of FIG. 4.

In the second exemplary embodiment, the brake device 10 b is arranged between the drive machine 3 and the step-up gearing 4. The rotor axis 11 is non-rotatably connected and/or connectable to the input shaft 28 of the brake device 10 b. The input shaft 28 is connected and/or can be connected in a rotationally fixed manner to the gearing input 6, which in the second embodiment is again designed as a sun shaft 23. The brake device 10 b is integrated together with the drive machine 3 and the step-up gearing 4 in the main housing 14.

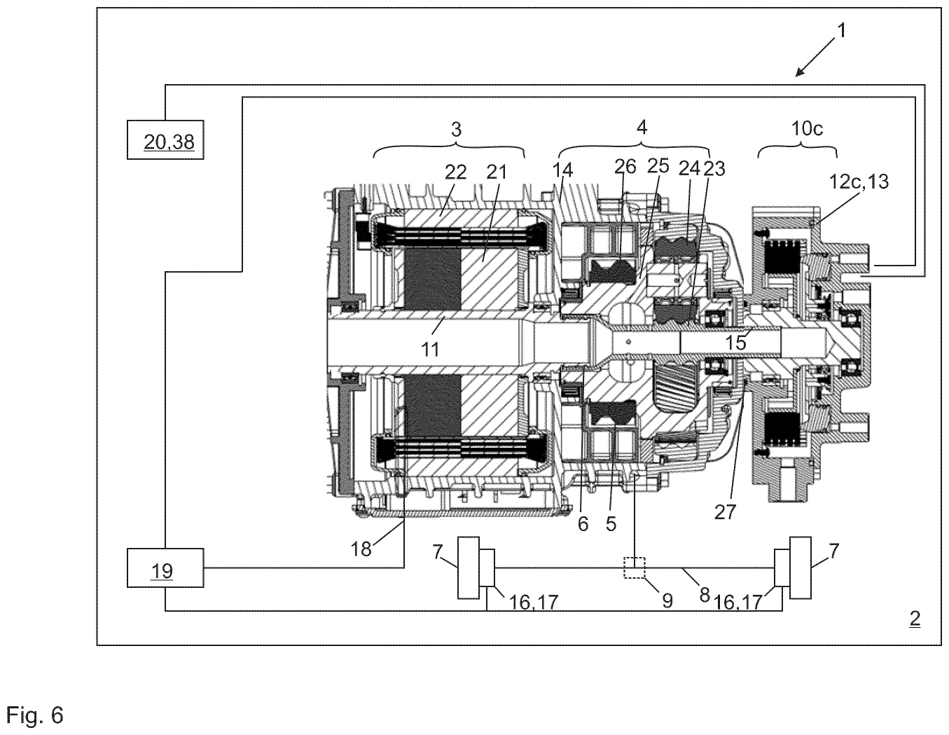

FIG. 6 shows a schematic longitudinal section through a structural design of the drive arrangement 1 according to the third exemplary embodiment of the disclosure, wherein the same components and areas are provided with the same reference symbols as in FIG. 1, so that reference is made to the previous description and only the structural details are discussed below. For the torque paths, reference is also made to the previous figures. For the structural details of the drive arrangement 1, reference is made to the description of FIG. 3, wherein only the differences are described below. For the structural details of the brake device 10 c, reference is made to the description of FIG. 4, wherein the brake device 10 c is designed to be structurally identical, but mirror-inverted, to the brake device 10 a.

On the right side, the brake device 10 c can be seen in the additional module 12 c. The additional module 12 c has the module housing 13, wherein the additional module 12 c and/or the module housing 13 is detachably connected to the main housing 14 via screw connections 27. The rotor shaft 11 is connected in a rotationally fixed manner via the gearing input 6, here the sun shaft 23, and the step-up gearing 4 to the torque interface 15, here the input shaft 28.

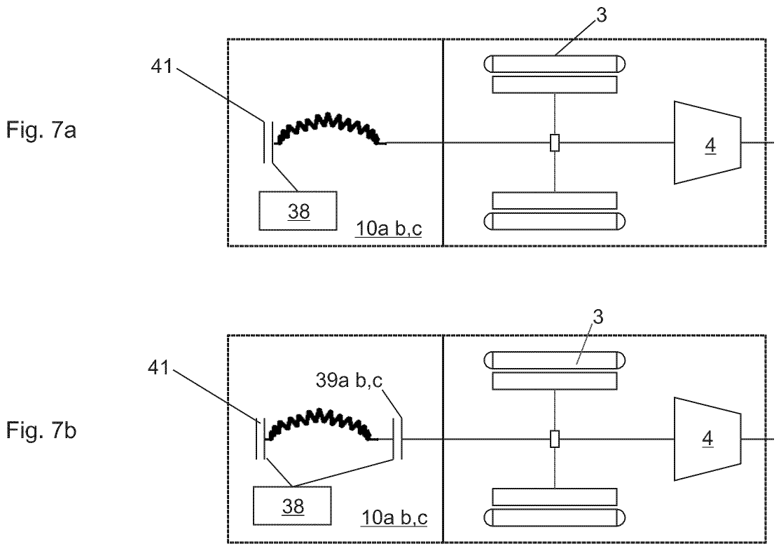

FIG. 7 a, b show a schematic representation of the implementation of vibration damping. The drive machine 3, the step-up gearing 4 and the brake device 10 a , b, c are each shown.

FIG. 7 a shows an alternative, wherein the brake device 10 a, b, c is permanently coupled to the system comprising the drive machine 3, the step-up gearing 4 and optionally further components. The vibration management device 38 controls the brake device 10 a, b, c so that the system is detuned by the friction torque and, for example, the frequency position of any resonance frequencies is displaced. In this way, vibrations in the system can be damped and/or compensated.

FIG. 7 b shows a further alternative, wherein the brake device 10 a, b, c has the brake coupling device 39 a, b, c. A first stage of detuning is achieved by coupling the brake device 10 a, b, c and its rotating mass. As a result, the rotatable part of the disc pack of the multi-disc brake 41 is coupled to the system. The additional mass detunes the system.

In a further step, after coupling the rotatable part of the disc pack, the disc pack and/or the multi-disc brake 41 can be closed. This allows the system to be detuned in a fully variable manner.

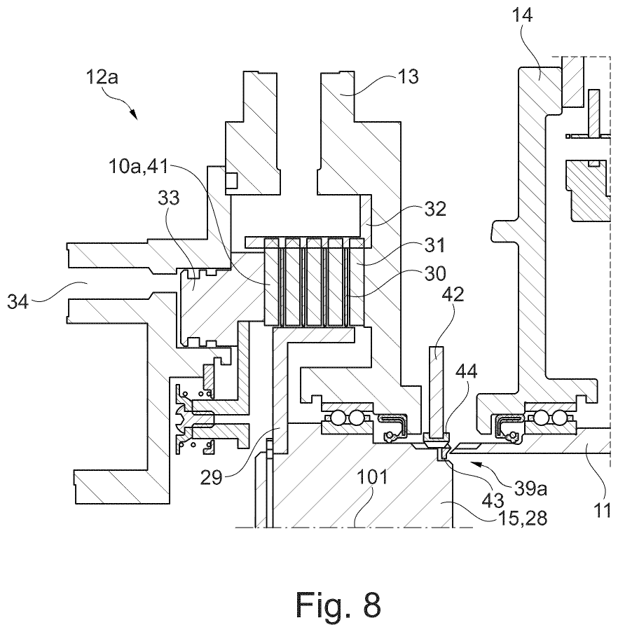

FIG. 8 shows the additional module 12 a in a similar representation as in FIG. 4, wherein reference is made to the corresponding description. In contrast to FIG. 4, the drive arrangement 1 and/or the vehicle 2 has the brake coupling device 39 a. The brake coupling device 39 a is designed as a synchronization device between the input shaft 28 and the rotor shaft 11. The set-up between the two housings is worth mentioning here. By moving the lever 42 on a sliding sleeve in the axial direction, the speed can first be adjusted via a friction cone 43 and then a claw coupling 44 can be moved over the two shaft ends. In the arrangement shown, the claw coupling 44 is mounted on the non-permanently rotating part (not the engine side, but the friction system side). This leads to less wear and less drag torque at the engagement of the lever 42. The brake coupling device 39 a is controlled by the vibration management device 38. The other brake coupling devices 39 b, c can be designed to be structurally identical.

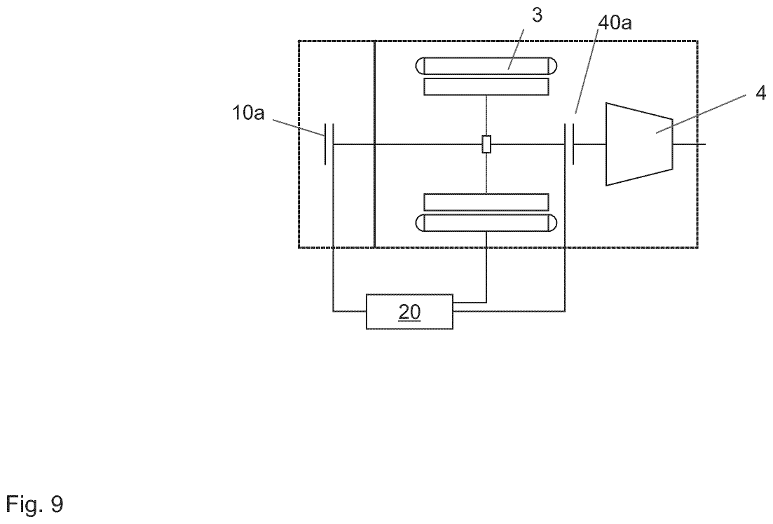

FIG. 9 shows a schematic block diagram of an example of the structure of an auxiliary heater for the vehicle 2. The temperature management device 20 controls the drive machine 3, the brake device 10 a and the drive coupling device 40 a, so that the step-up gearing 4 is separated from the drive machine 3, but the latter is in operative connection with the brake device 10 a. Subsequently, a driving torque is generated by the drive machine 3 and directed to the brake device 10 a, which brakes the driving torque in order to actively generate braking heat. The braking heat can subsequently be used by the temperature management device 20 to supply it to the useful functions described. The other brake devices 10 b, c can be controlled in the same way.

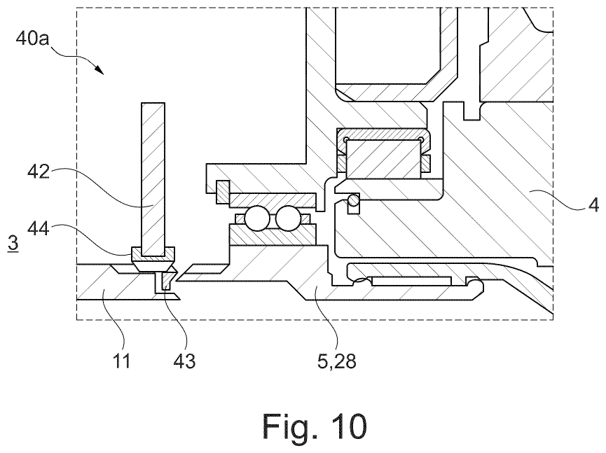

FIG. 10 shows a schematic longitudinal sectional view of the drive coupling device 40 a, which is substantially identical in construction to the brake coupling device 39 aof FIG. 8, but in contrast to the latter, detachably connects the rotor shaft 11 to the gearing input 6 and/or the sun shaft 23. For the description of the drive coupling device 40 a, reference is made to FIG. 8. The positioning of the drive coupling device 40 a upstream of the step-up gearing 4 is advantageous because it can be controlled directly with the engine speed. This allows for higher speeds at lower torques in typical applications.

### REFERENCE NUMERALS

1 Drive arrangement
2 Vehicle
3 Electric drive machine
4 Step-up gearing
5 Gearing output
6 Gearing input
7 Driven wheel
8 Axle
9 Differential
10 Brake device
11 Rotor shaft
12 a, c Additional module
13 Module housing
14 Main housing
15 Torque interface
16 Service brake
17 Friction brake
18 Recuperation brake
19 Brake management device
20 Temperature management device
21 Rotor
22 Stator
23 Sun shaft
24 Planetary gears
25 Planetary carrier
26 Spur gear toothing
27 Screw connections
28 Input shaft
29 Inner ring
30 Friction discs
31 Steel discs
32 Outer ring
33 Piston
34 Holes for hydraulic fluid
35 Springs
36 Module interior
37 Further holes
38 Vibration management device
39 a, b, c Brake coupling device
40 a, b Drive coupling device
41 Multi-disc brake
42 Lever
43 Friction cone
44 Claw coupling
100 a, b, c Braking torque path
101 Brake rotational axis
102 Rotor rotational axis
103 Driving torque path
104 Driving torque counter-path
105 Driving torque branch path

1. A vehicle comprising:
a drive arrangement, the drive arrangement comprising:
an electric drive machine for generating a driving torque for the vehicle, and
a step-up gearing for stepping up the driving torque, wherein the step-up gearing has a gearing input for receiving the driving torque and a gearing output for outputting a stepped-up driving torque in the direction of at least one driven wheel of the vehicle such that a driving torque path from the drive machine to the gearing output and/or to the at least one driven wheel is formed, and
a brake device wherein the brake device can be brought into operative connection with the driving torque path in order to bring a braking torque along a braking torque path onto the at least one driven wheel, wherein:
the brake device has a friction brake device with a temperature control fluid for lubricating and/or cooling the friction brake device.

2. The vehicle according to claim 1, wherein the vehicle has a temperature management device, wherein the temperature management device is designed to supply the braking heat of the friction brake device to a useful function via the temperature control fluid.

3. The vehicle according to claim 2, wherein the drive arrangement has a drive coupling device for interrupting the driving torque path, wherein the temperature management device is designed to control the drive coupling device in order to interrupt the driving torque path and to control the drive machine and the brake device in order to generate braking heat for the useful function.

4. The vehicle according to claim 1, wherein the vehicle has a vibration management device, wherein the vibration management device is designed to compensate, modulate and/or dampen vibrations occurring in the drive arrangement and/or in the vehicle by controlling the brake device.

5. The vehicle according to claim 4, wherein the brake device has a brake coupling device for separating the friction brake device from the braking torque path wherein the vibration management device is designed to close the brake coupling device in order to compensate and/or dampen vibrations that occur.

6. The vehicle according to claim 1, wherein the vehicle has a service brake and the brake device is designed as a complementary brake and/or as a supplementary brake device to the service brake.

7. The vehicle according to claim 6, further comprising a brake management device for controlling the service brake and the brake device, wherein the brake management device is designed to implement a comfort braking state, wherein, in the comfort braking state, the main braking deceleration is carried out by the brake device in order to bring the vehicle to a standstill.

8. The vehicle according to claim 1, wherein:
the brake device is and/or can be connected in a rotationally fixed manner to the gearing input of the step-up gearing and/or to a rotor shaft of the drive machine, or
in that the braking torque path runs via the step-up gearing, wherein the brake device is arranged in the braking torque path upstream of the step-up gearing and/or wherein the brake device can be operated at the engine speed of the drive machine.

9. The vehicle according to claim 1, wherein the braking torque path runs via the electric drive machine and in that the brake device is arranged in the braking torque path upstream of the electric drive machine.

10. The vehicle according to claim 1, wherein the brake device is arranged in the driving torque path between the drive machine and the step-up gearing.

11. The vehicle according to claim 1, wherein the drive machine is arranged on one axial side of the step-up gearing and the brake device is arranged on the other axial side of the step-up gearing.
